(19) United States
(12) Patent Application Publication
(10) Pub. No.: US 2017/0355212 A1
(43) Pub. Date: Dec. 14, 2017

(54) PRINTING BOOK INCLUDING A FIRST ATTACHMENT DEVICE

(71) Applicant: Zoran Rosomanov, Skopje (MK)

(72) Inventor: Zoran Rosomanov, Skopje (MK)

(21) Appl. No.: 15/617,033

(22) Filed: Jun. 8, 2017

(30) Foreign Application Priority Data
Jun. 9, 2016 (EP) 16 173 833.1

(51) Int. Cl. B42D 1/00

(52) U.S. Cl. CPC B42D 1/005; B42D 1/007; B42D 1/006

(57) ABSTRACT

A printed book has at least a first page and a second page, wherein the first page including a first attachment device for attaching a sheet onto the first page within a first attachment area and the first page including a first detachment device for separating a first detachment area from the first page, the second page including a second attachment device for attaching a sheet onto the second page within a second attachment area and the second page including a second detachment device for separating a second detachment area from the second page, and, when the printed book is in a closed condition, the first attachment area being congruent with the second detachment area and the first detachment area being congruent with the second attachment area.

### BACKGROUND

### 1. Field of the Invention

The invention reflates to a printed book having at least a first page and a second page, wherein the first page including a first attachment device for attaching a sheet onto the first page within a first attachment area.

### 2. Description of the Related Art

Printed books are nowadays used for all sorts of presentation of information. In particular, such books are used in business relationships and during exhibitions and conferences.

When using such books it is common knowledge to provide one single page of the book or presentation map with two slots into which a usual business card can be attached to the respective page of the book. The business card may then be taken out of said slots for future use of the book user. Thus, such slots constitute a common attachment device for attaching a sheet onto said page of the book to be considered.

The printed book thereby becomes a medium for transmitting business information to the book user in a rather standardized form, while the business card works as an insertable and detachable content of the book.

It is an object of the present invention to improve usability of a common printed book, in particular to improve its use during exhibitions and conferences.

### SUMMARY

According to the invention a printed book is created, the printed book having at least a first page and a second page, wherein the first page including a first attachment device for attaching a sheet onto the first page within a first attachment area and the first page including a first detachment device for separating a first detachment area from the first page, the second page including a second attachment device for attaching a sheet onto the second page within a second attachment area and the second page including a second detachment device for separating a second detachment area from the second page, and, when the printed book is in a closed condition, the first attachment area being congruent with the second detachment area and the first detachment area being congruent with the second attachment area.

Preferably, the printed book has a binding edge at which the first page is foldably attached to the second page, and the first detachment area is located relative to the binding edge at the upper outer corner of the first page and the first attachment area is located relative to the binding edge at the lower outer corner of the first page.

The second attachment area advantageously is located relative to the binding edge at the upper outer corner of the second page and the second detachment area is located relative to the binding edge at the lower outer corner of the second page.

The binding edge is preferably provided by means of a spiral binding. The spiral binding enables the user of the book to fold its pages completely backward. Furthermore, the spiral binding balances minor amendments in respect of the thickness of the pages of the book.

At least one of the first attachment area and the second attachment area advantageously is adapted in size to attach a usual business card therein.

At least one of the first attachment device and the second attachment device preferably is provided with at least two slots into which the sheet to be attached may be inserted. Such slots can be added to the pages of the book in a very cheap manner.

In a further preferred manner, at least one of the first attachment area and the second attachment area is rectangular.

At least one of the first detachment device and the second detachment device preferably is provided with at least one perforation line at which said detachment area may be separated from the remaining first or second page, respectively. Such perforation lines can be added to the pages of the book in a very cost effective manner, in particular in one manufacturing step together with said slots of the attachment device.

Furthermore, at least one of the first detachment area and the second detachment area advantageously is rectangular, and, in particular, at least one of the first detachment area and the second detachment area has the size of a usual business card.

Finally, in a preferred embodiment of the invention the printed book contains at least five first pages and at least five second pages, preferably the printed book contains at least twenty first pages and at least twenty second pages.

The inventive printed book does not only include one single attachment device for attaching therein an addition sheet, in particular a sheet of paper, a sheet of plastic, wood, veneer, cork, leather, wool, or the like, particularly a common business card, but does include at least two such attachment devices, preferably more than two such attachment devices, namely at least five, or even more preferably more than twenty such attachment devices. With these attachment devices the user of the printed book is able to add into the book those addition sheets he is provided with during an exhibition, a conference, a meeting, gatherings, events, etc. The user may place the additional sheets, particularly business cards of his discussion partners and interested parties, into the book in an orderly manner. The important factor about it is that each addition sheet is placed on one page of the printed book, thus enabling the user of the printed book to add some addition notes onto said page, too.

Furthermore, the inventive printed book is provided with a detachable area on each of said pages. This detachable area may be separated from the page by the user and may be handled out to the discussion partner, in particular to said discussion partner from which the user receives or received a business card. The detachment area can be personalised to carry individual information of the books' user, like personal contact details, or it can carry any other information based on user's preferences. In doing so, the user receives a proper documentation of all its discussions and contacts during an exhibition, a conference, a meeting, gatherings, events, etc. This example of use of the printed book according to the invention shows its uniqueness and distinctiveness. There surely are many other possibilities of use which are all even not known today. By improving a common books' usability, the invention becomes an operational and organizational, personalised tool for transmitting and exchanging information on all kinds of meetings.

However, the inventive solution is not only directed to a multiple provision of known attachment and detachment devices at paper pages but is also directed to a particular arrangement of these devices. According to the invention the first attachment area is congruent with the second detachment area and the first detachment area is congruent with the second attachment area when the printed book is in a closed condition. In other words, when the book according to the invention is closed, said areas are located within the two sheets in such a manner that the attachment areas and detachment areas alternate from page to page. In this way, when using the book, the user detaches a detachment area from the one page and adds an additional sheet on the other page within the same page area thereafter. This detachment and attachment on different pages within the same page area does not make the pages of the book thicker in total even though additional sheets were added into the book. The interchanging of the attachment and detachment devices from page to page balances the attached and detached sheets, so the book is even, and aids to not making the printed book thicker.

### BRIEF DESCRIPTION OF THE DRAWINGS

FIG. 1 is a first perspective view of an embodiment of a printed book according to the invention.

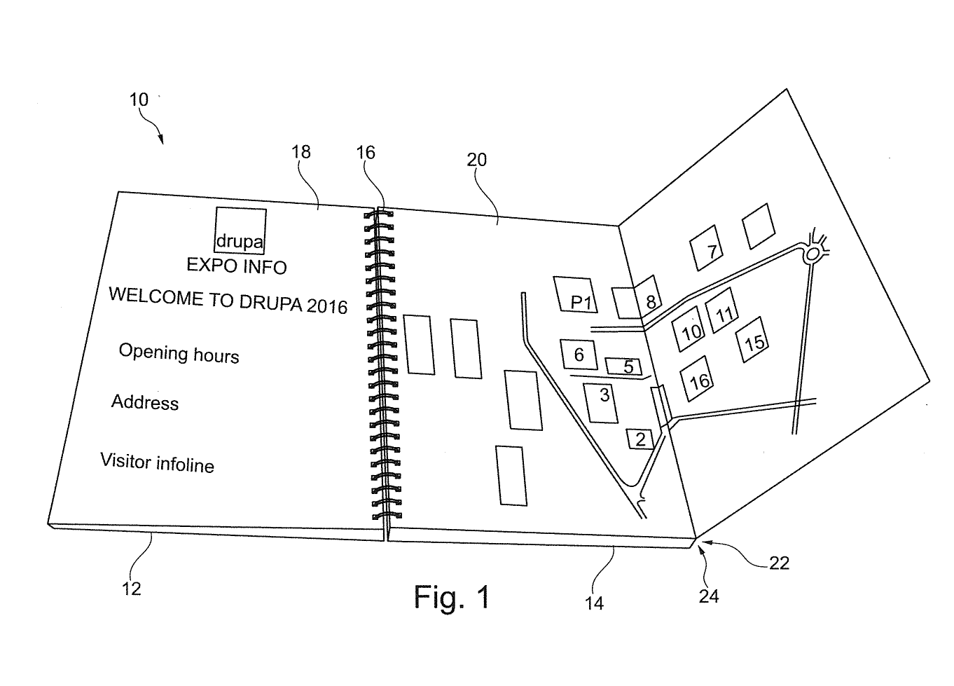

FIG. 2 is a second perspective view of the printed book according to FIG. 1.

FIG. 3 is a third perspective view of the printed book according to FIG. 1.

### DETAILED DESCRIPTION

A printed book 10 is provided with two hard covers, a front cover 12 and a back cover 14, each on one side of the book 10. The covers 12 and 14 are connected to each other by means of a binding edge, in particular a spiral binding 16, onto which twelve further pages are pivotally located.

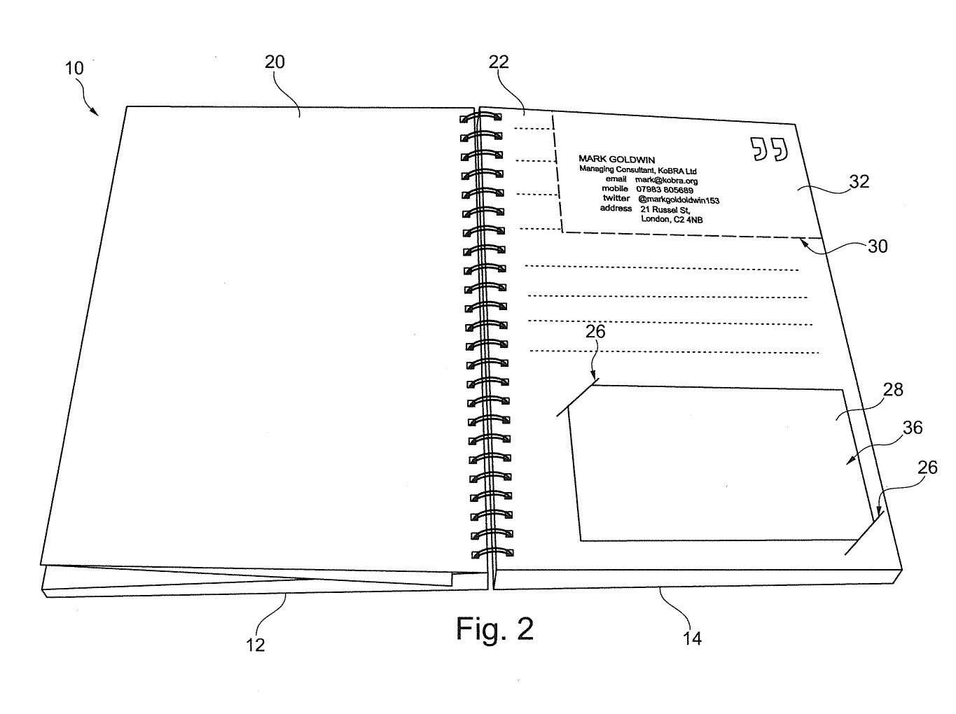

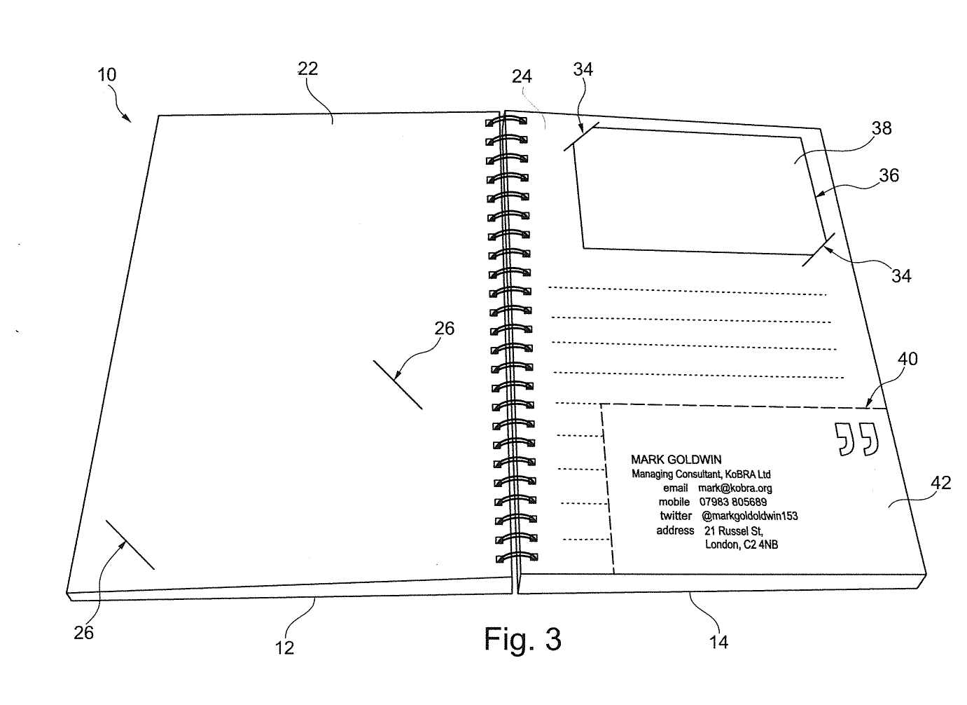

The pages include an introduction page 18, a survey page 20, ten first pages 22 and ten second pages 24. Of these twenty first and second pages 22 and 24 only two are shown in further detail in FIGS. 2 and 3.

The introduction page 18 includes some introductory information and is located on the inner side of the front cover 12. The survey page 20 includes a map and/or some further general information. The survey page 20 is located after the introduction page 18 and includes a flap or hinged page which can be pivoted outward when opening the printed book 10 at that survey page 20.

The shown first page 22 includes a first attachment device 26 in the form of two diagonal short slots for attaching a sheet 36, in particular a usual business card, onto the first page 22 within a first rectangular attachment area 28.

The first page 22 further includes a first detachment device 30 in the form of an angled perforation line for separating a first detachment area 32 from the first page 22.

The second page 24 includes a second attachment device 34 in the form of two diagonal short slots for attaching a sheet 36, in particular another usual business card, onto the second page 24 within a second rectangular attachment area 38.

The second page 24 further includes a second detachment device 40 in the form of an angled perforation line for separating a second detachment area 42 from the second page 24.

The attachment and detachment areas 28, 32, 38 and 42 are located on said pages 22 and 24 in such a manner that, when the printed book 10 is in a closed condition, the first attachment area 28 being congruent with the second detachment area 42 and the first detachment area 32 being congruent with the second attachment area 38.

In particular, the first detachment area 32 is located relative to the spiral binding 16 at the upper outer corner of the first page 22 and the first attachment area 28 is located relative to the spiral binding 16 at the lower outer corner of the first page 22.

The second attachment area 38 is located relative to the spiral binding 16 at the upper outer corner of the second page 24 and the second detachment area 42 is located relative to the spiral binding 16 at the lower outer corner of the second page 24.

The first attachment area 28 and the second attachment area 38 are adapted in size to attach a usual business card therein, and the first detachment area 32 and the second detachment area 42 have the size of a usual business card.

### REFERENCE LIST

10 printed book
12 front cover
14 back cover
16 spiral binding
18 introduction page
20 survey page
22 first page
24 second page
26 first attachment device
28 first attachment area
30 first detachment device
32 first detachment area
34 second attachment device
36 sheet
38 second attachment area
40 second detachment device
42 second detachment area

What is claimed is:

1. A printed book (10) comprising at least a first page (22) and a second page(24), wherein the first page (22) including a first attachment device (26) for attaching a sheet (36) onto the first page (22) within a first attachment area (28) and the first page (22) including a first detachment device (30) for separating a first detachment area (32) from the first page (22), the second page (24) including a second attachment device (34) for attaching a sheet onto the second page (24) within a second attachment area (38) and the second page (24) including a second detachment device (40) for separating a second detachment area (42) from the second page (24), and, when the printed book (10) is in a closed condition, the first attachment area (28) being congruent with the second detachment area (42) and the first detachment area (32) being congruent with the second attachment area (38).

2. The printed book (10) of claim 1, further comprising a binding edge at which the first page (22) is foldably attached to the second page (24), and the first detachment area (32) being located relative to the binding edge at the upper outer corner of the first page (22) and the first attachment area (28) being located relative to the binding edge at the lower outer corner of the first page (22).

3. The printed book (10) of claim 2, wherein the second attachment area (38) is located relative to the binding edge at the upper outer corner of the second page (24) and the second detachment area (42) is located relative to the binding edge at the lower outer corner of the second page (24).

4. The printed book (10) of claim 3,
wherein the binding edge is provided by means of a spiral binding (16).

5. The printed book (10) of claim 4, wherein at least one of the first attachment area (28) and the second attachment area (38) is adapted in size to attach a business card therein.

6. The printed book (10) of claim 5, wherein at least one of the first attachment device (26) and the second attachment device (34) is provided with at least two slots into which the sheet to be attached may be inserted.

7. The printed book (10) of claim 6, wherein at least one of the first attachment area (28) and the second attachment area (38) is rectangular.

8. The printed book (10) of claim 7, wherein at least one of the first detachment device (30) and the second detachment device (40) is provided with at least one perforation line at which said detachment area (42) may be separated from the remaining first (22) or second page (24).

9. The printed book (10) of claim 1, wherein at least one of the first detachment area (32) and the second detachment area (42) is rectangular, and at least one of the first detachment area (32) and the second detachment area (42) has the size of a business card.

10. The printed book (10) of claim 1, comprising at least five first pages (22) and at least five second pages (24), preferably containing at least twenty first pages (22) and at least twenty second pages (24).

11. The printed book (10) of claim 1, comprising at least twenty first pages (22) and at least twenty second pages (24).

12. The printed book (10) of claim 1,
wherein the binding edge is provided by means of a spiral binding (16).

13. The printed book (10) of claim 1, wherein at least one of the first attachment area (28) and the second attachment area (38) is adapted in size to attach a business card therein.

14. The printed book (10) of claim 1, wherein at least one of the first attachment device (26) and the second attachment device (34) is provided with at least two slots into which the sheet to be attached may be inserted.

15. The printed book (10) of claim 1, wherein at least one of the first attachment area (28) and the second attachment area (38) is rectangular.

16. The printed book (10) of claim 6, wherein at least one of the first detachment device (30) and the second detachment device (40) is provided with at least one perforation line at which said detachment area (42) may be separated from the remaining first (22) or second page (24).
